(19) United States
(12) Patent Application Publication
(10) Pub. No.: US 2016/0089921 A1
(43) Pub. Date: Mar. 31, 2016

(54) THERMAL TRANSFER SHEET

(71) Applicant: DAI NIPPON PRINTING CO., LTD., Tokyo (JP)

(72) Inventor: Yusaku AKIYAMA, Tokyo (JP)

(21) Appl. No.: 14/870,874

(22) Filed: Sep. 30, 2015

(30) Foreign Application Priority Data
Sep. 30, 2014 (JP) 2014-200455

(51) Int. Cl. B41M 5/44; B41M 5/382; B41M 5/42

(52) U.S. Cl. CPC B41M 5/44; B41M 5/423; B41M 5/38228; B41M 2205/02; B41M 2205/36

(57) ABSTRACT

[Object] To provide a thermal transfer sheet capable of inhibiting occurrence of kicks as well as inhibiting occurrence of printing irregularities by satisfying the slidability of the back face layer upon image formation in the low gradation area and the halftone gradation area.

[Means for achieving the Object]

The above object can be achieved by providing a thermal transfer sheet 10 in which one or both of a color material layer 3 and a protective layer 4 is provided on one surface of a substrate 1, and a back face layer 5 is provided on another one surface of the substrate 1, the thermal transfer sheet being characterized in that the back face layer 5 is contained with (i) a cured acrylic polyol resin in which an acrylic polyol resin is cured by a curing agent, and (ii) a glycerin fatty acid ester or a polyglycerin fatty acid ester.

### BACKGROUND OF THE INVENTION

1. Field of the Invention

The present invention relates to a thermal transfer sheet.

2. Description of the Related Art

As a simple printing method, various thermal transfer recording methods are widely used. In each thermal transfer recording method, a thermal transfer sheet that has, for example, yellow, magenta, and cyan (black, as required) color material layers being frame sequentially and repeatedly provided in large numbers on a continuous substrate is mainly used. The thermal transfer recording methods are roughly divided into the heat-fusion type recording method in which color material layers are melted and softened by heating and migrate onto a thermal transfer receiving sheet to form an image and the sublimation type recording method in which dyes in color material layers migrate by heating onto a transfer receiving article to form an image. Among them, the sublimation type recording method is applied for color image formation in digital cameras, videos, computers, and the like because the method, which employs sublimable dye as the color material, excels in color reproducibility and gradation of halftones and can vividly represent a full-color image as per the original on a receiving sheet. The image is a high quality one comparable to silver halide photography.

A thermal transfer sheet is generally wound around to a predetermined wound diameter and stored. When the color material contained in the color material layer is in a localized state on the surface of the color material layer due to bleeding and the like, the color material becomes apt to migrate (so-called kick) to the back face layer side of the thermal transfer sheet. Then, when the color material migrated to the back face layer side migrates (so-called kicks back) to the color material layer side again, particularly when, in a thermal transfer sheet that has each color material layer having a different hue and frame-sequentially provided, a color material which has migrated to the back face layer side migrates to other color material layer that has a hue different from that of the color material, reduction in the color developing characteristics occurs on image formation by use of the other color material layer.

In view of the above mentioned circumstances, various studies of the thermal transfer sheet for preventing kicks from occurring have been made. For example, in the Patent literature 1, a thermal transfer sheet, where a dye layer is provided on one surface of the substrate, and a back face layer is provide on the other surface of the surface, and where the dye layer contains an indoaniline dye, polyvinyl acetal resin A, and polyvinyl acetal resin B (polyvinyl acetal resin represented by the general formula (1) in the Patent literature 1), has been proposed. By use of this thermal transfer sheet, it is supposed that migration of the dye to the back face layer side can be prevented during storage of the thermal transfer sheet. In the thermal transfer sheet proposed by the Patent literature 1, however, a problem of having few options for materials is inherent because types of dyes and binder resins contained in the dye layer are limited to the predetermined components.

Further, when the back face layer of the thermal transfer sheet has low slidability, printing irregularities are prone to occur in images to be formed. It can thus be said that it is important for the back face layer of the thermal transfer sheet to have good slidability in order to inhibit occurrence of printing irregularities. Incidentally, heat applied to the heating member such as the thermal head upon image formation depends on image information. For example, even when the slidability upon image formation in the high gradation area is sufficiently satisfied, it is not possible to inhibit occurrence of printing irregularities when the slidability upon image formation in the low gradation area or the halftone gradation area is low. Further, at present, slip agents mainly focused on inhibition of kicks cannot sufficiently satisfy the slidability upon image formation in the low gradation area and the halftone gradation area. The need is high for a back face layer that can inhibit occurrence of kicks as well as can sufficiently satisfy the slidability upon image formation in the low gradation area and the halftone gradation area.

### PRIOR ART LITERATURE

### Patent Literature

### Patent Document 1: JP 2009-286060 A

### SUMMARY OF THE INVENTION

The present invention has been made in view of the above mentioned circumstances, and the present invention aims principally to provide a thermal transfer sheet that can inhibit occurrence of kicks as well as can inhibit occurrence of printing irregularities by satisfying the slidability of the back face layer upon image formation in the low gradation area and the halftone gradation area.

An aspect of the present invention for solving the above mentioned problems is a thermal transfer sheet which comprises a substrate, one or both of a color material layer and a protective layer provided on one surface of the substrate, and a back face layer provided on the other surface of the substrate; wherein the back face layer comprises (i) a cured acrylic polyol resin in which an acrylic polyol resin is cured by a curing agent, and (ii) a glycerin fatty acid ester or a polyglycerin fatty acid ester.

Further, the back face layer may contain, as the (ii), a glycerin fatty acid ester having a melting point of not more than 25° C. or a polyglycerin fatty acid ester having a melting point of not more than 25° C.

Further, the back face layer may contain, as the (i), a cured acrylic polyol resin in which an acrylic polyol resin having a glass transition temperature (Tg) of not less than 80° C. and not more than 120° C. is cured by a curing agent.

Further, the back face layer may further contain a cellulose acetate butyrate resin.

According to the thermal transfer sheet of the present invention, it is possible to inhibit occurrence of kicks as well as to inhibit occurrence of printing irregularities by satisfying the slidability of the back face layer upon image formation in the low gradation area and the halftone gradation area.

### BRIEF DESCRIPTION OF THE DRAWINGS

FIG. 1 is a schematic sectional view showing an example of the thermal transfer sheet of the present invention;

FIG. 2 is a schematic sectional view showing an example of the thermal transfer sheet of the present invention; and

FIG. 3 is a schematic sectional view showing an example of the thermal transfer sheet of the present invention.

### DETAILED DESCRIPTION OF THE PREFERRED EMBODIMENTS

### Thermal Transfer Sheet

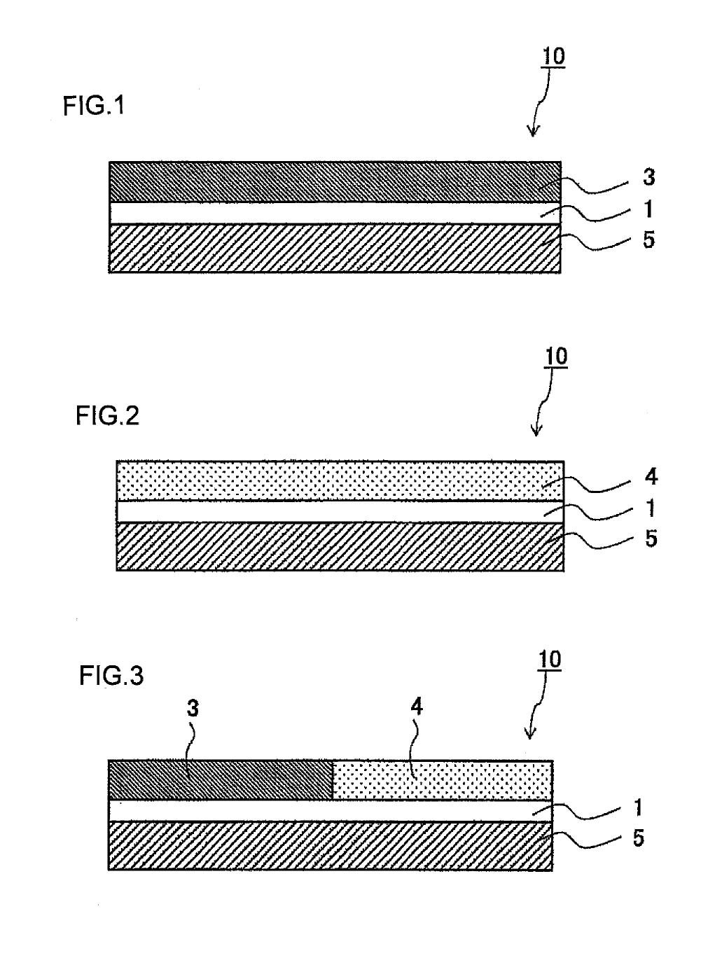

Hereinafter, the thermal transfer sheet according to an embodiment of the present invention will be described concretely with reference to the drawings. Incidentally, FIGS. 1 to 3 are schematic sectional views showing an example of the thermal transfer sheet of the present invention.

As shown in FIGS. 1 to 3, a thermal transfer sheet 10 of an embodiment of the present invention includes a substrate 1, a color material layer 3 and/or a protective layer 4 provided on one surface of the substrate 1, and a back face layer 5 provided on the other surface of the substrate 1. Incidentally, FIG. 1 is a schematic sectional view of the thermal transfer sheet in which the color material layer 3 is provided on one surface of the substrate 1. FIG. 2 is a schematic sectional view of the thermal transfer sheet in which the protective layer 4 is provided on one surface of the substrate 1. FIG. 3 is a schematic sectional view of the thermal transfer sheet in which the color material layer 3 and the protective layer 4 are frame-sequentially provided on one surface of the substrate 1. Then, the thermal transfer sheet 10 according an embodiment of the present invention is characterized in that the back face layer 5 contains (i) a cured acrylic polyol resin in which an acrylic polyol resin is cured by a curing agent, and (ii) a glycerin fatty acid ester or a polyglycerin fatty acid ester. The thermal transfer sheet of the present invention is not limited to the embodiment shown in this figure. For example, in the thermal transfer sheet shown in FIGS. 1 and 3, a primer layer (not shown) may be provided between the substrate 1 and the color material layer 3. In the thermal transfer sheet as shown in FIGS. 2 and 3, a release layer (not shown) may be provided between the substrate 1 and the protective layer 4. Further, with respect to the embodiment shown in each figure, a back face primer layer (not shown) may be provided between the substrate 1 and the back face layer 5. Further, the color material layer 3 may take a construction in which plural color material layers having a different hue (3Y, 3M, and 3C) are frame-sequentially provided. Incidentally, the primer layer, the release layer, and the back face primer layer are optional components in the thermal transfer sheet 10 of the present invention. Hereinafter, the components constituting the thermal transfer sheet 10 will be described in detail.

### (Substrate)

The substrate 1 is an essential component of thermal transfer sheet 10 of the present invention, and is provided for the purpose of supporting the layer (the color material layer 3 and/or the protective layer 4) which is provided on one surface and the back face layer 5 provided on the other surface. The material for the substrate 1 is not particularly limited. However, it is desirable the material can resist heat which is added by a thermal head upon transfer of the color material layer 3 and/or the protective layer 4 onto a transfer receiving article, and has a sufficient mechanical strength for handling without a hitch. As such a material for the substrate, various plastic films or sheets, for instance, including, polyesters such as polyethylene terephthalate, polyarylates, polycarbonates, polyurethanes, polyimides, polyether imides, cellulose derivatives, polyethylenes, ethylene-vinyl acetate copolymers, polypropylenes, polystyrenes, acryl, polyvinyl chlorides, polyvinylidene chlorides, polyvinyl alcohols, polyvinyl butyrals, nylons, polyether ether ketones, polysulfones, polyether sulfones, tetrafluoroethylene-perfluoroalkyl vinyl ethers, polyvinyl fluorides, tetrafluoroethylene-ethylenes, tetrafluoroethylene-hexafluoropropylenes, polychlorotrifluoroethylenes, polyvinylidene fluorides, and the likes may be enumerated. Although the thickness of the substrate 1 can be appropriately selected depending on the kind of the material used so as to make it suitable in strength and heat resistance, the thickness is usually in the range of about 2 μm to about 100 μm, preferably of 1 to 10 μm.

### (Back Face Layer)

As shown in figures, the back face layer 5 is provided on the other surface of the substrate 1 (the bottom surface of the substrate 1 when shown in FIGS. 1 to 3). The back face layer contains a binder resin and a slip agent component. The thermal transfer sheet 10 according an embodiment is characterized in that the back face layer 5 contains, as the binder resin, (i) a cured acrylic polyol resin in which an acrylic polyol resin is cured by a curing agent, and, as the slip agent component, (ii) a glycerin fatty acid ester or a polyglycerin fatty acid ester.

According to the thermal transfer sheet 10 of an embodiment which comprises the back face layer 5 having above mentioned features, slidability upon image formation in the low gradation area and in the halftone gradation area is good, and can be stably maintained. In particular, the thermal transfer sheet according an embodiment of the present invention is characterized in that the back face layer 5 contains a cured acrylic polyol resin as the binder resin in order to satisfy the slidability upon image formation in the halftone gradation area and that the slidability upon image formation in the halftone gradation area is stabilized by the action of the cured acrylic polyol resin. According to the thermal transfer sheet 10 of an embodiment which can satisfy the slidability of the back face layer upon image formation in the halftone gradation area, occurrence of printing irregularities on gray image formation can be inhibited. Incidentally, the printing irregularities used herein mean a phenomenon in which lateral-stepped color irregularities occur. The precise mechanism about why the printing irregularities occur has been not fully elucidated so far. However, it has been assumed that reduction in the slidability of the back face layer increases the friction between the heating member such as the thermal head and the back face layer thereby to cause sticking, which influences occurrence of the printing irregularities. Incidentally, even though not depending on the mechanism, the fact that occurrence of the printing irregularities can be inhibited by allowing the thermal transfer sheet to include the back face layer 5 which contains (i) the cured acrylic polyol resin and (ii) the glycerin fatty acid ester or polyglycerin fatty acid ester is evident from the results of examples described below.

Hereinafter, the binder resin and slip agent component contained in the back face layer 5, mainly, (i) a cured acrylic polyol resin and (ii) a glycerin fatty acid ester or polyglycerin fatty acid ester will be described.

### <Cured Acrylic Polyol Resin>

The back face layer 5 contains, as an essential binder resin, a cured acrylic polyol resin in which an acrylic polyol resin is cured by a curing agent. According to the back face layer 5 containing the cured acrylic polyol resin, it is possible to provide good slidability of the back face layer upon image formation in the halftone gradation area and to inhibit occurrence of printing irregularities on gray image formation.

The mechanism about why the above mentioned effect is achieved when the back face layer 5 contains the cured acrylic polyol resin has been not elucidated so far. However, when an uncured acrylic polyol resin, instead of the cured acrylic polyol resin, is contained in the back face layer, it is not possible to satisfy the slidability in the halftone gradation area and to sufficiently inhibit the occurrence of printing irregularities on gray image formation. Further, when a cured resin in which a resin other than acrylic polyol resins is cured by a curing agent, instead of the cured acrylic polyol resin is contained in the back face layer, for example, also when, as the binder resin of the back face layer, a generally known polyvinyl acetal resin or a cured resin in which a polyvinyl acetal resin is cured by a curing agent is contained in the back face layer, it is not possible to satisfy the slidability in the halftone gradation area.

Further, it is assumed that the above mentioned good slidability upon image formation in the halftone gradation area is not provided by an effect singly by the cured acrylic polyol resin, but a synergistic effect of the cured acrylic polyol resin with a glycerin fatty acid ester or a polyglycerin fatty acid ester described below. This is because the slidability of the back face layer which contains neither glycerin fatty acid ester nor polyglycerin fatty acid ester, even when the back face layer contains a cured acrylic polyol resin, upon image formation in the halftone gradation area becomes lower than the slidability of the back face layer which contains a cured acrylic polyol resin and a glycerin fatty acid ester or polyglycerin fatty acid ester upon image formation in the halftone gradation area.

The acrylic polyol resin used herein means an acrylic resin having hydroxyl group(s), for instance, an acrylic polyol resin obtained by copolymerizing one or more kinds of (meth)acrylic acid alkyl esters, such as, methyl (meth)acrylate, ethyl (meth)acrylate, butyl (meth)acrylate, 2-ethylhexyl (meth)acrylate, octyl (meth)acrylate, and one or more kinds of (meth)acrylic ester involving hydroxyl group(s) in its molecule, such as 2-hydroxyethyl (meth)acrylate, 2-hydroxybutyl (meth)acrylate, 2-hydroxy-3-phenoxypropyl (meth)acrylate, and optionally, one or more kinds of other polymerizable monomers such as styrene can be enumerated. Concretely, for instance, methyl (meth)acrylate-2-hydroxyethyl (meth)acrylate copolymer, octyl (meth)acrylate-ethyl hexyl (meth)acrylate-2-hydroxyethyl (meth)acrylate copolymer, methyl (meth)acrylate-butyl (meth)acrylate-2-hydroxyethyl (meth)acrylate-styrene copolymer, and the like, can be exemplified. Here, the word “(meth)acrylate” means acrylate or methacrylate.

As the curing agent for curing the above mentioned acrylic polyol resin, isocyanate curing agents, and metal chelating agents such as titanium chelating agents, zirconium chelating agents, and aluminum chelating agents can be enumerated. The isocyanate curing agent cross-links the acrylic polyol resin having hydroxyl groups by utilizing their hydroxyl groups. As the isocyanate curing agent, a polyisocyanate resin can be preferably used. Although various types are conventionally known in the art as the polyisocyanate resin, it is preferable to use an adduct of aromatic isocyanate. As the aromatic polyisocyanate, for instance, 2,4-toluene diisocyanate, 2,6-toluene diisocyanate, or a mixture of 2,4-toluene diisocyanate and 2,6-toluene diisocyanate, 1,5-naphtalene diisocyanate, tolidine diisocyanate, p-phenylene diisocyanate, trans-cyclohexane, 1,4-diisocyanate, xylylene diisocyanate, triphenyl methane triisocyanate, and tris(isocyanate phenyl) thiophosphate may be enumerated. Among them, 2,4-toluene diisocyanate, 2,6-toluene diisocyanate, or a mixture of 2,4-toluene diisocyanate and 2,6-toluene diisocyanate are particularly preferable.

The glass transition temperature (Tg) of the acrylic polyol resin for obtaining the above mentioned cured acrylic polyol resin is not particularly limited. However, it is preferable that the back face layer 5 contains a cured acrylic polyol resin in which an acrylic polyol resin having a glass transition temperature (Tg) of not less than 80° C. and not more than 120° C. is cured by a curing agent. According to this back face layer 5, as compared with the back face layer 5 which contains a cured acrylic polyol resin in which an acrylic polyol resin having glass transition temperature (Tg) of less than 80° C. or more than 120° C. is cured by a curing agent, particularly good slidability upon image formation in the halftone gradation area is provided. Incidentally, the glass transition temperature (Tg) of the acrylic polyol resin or the glass transition temperature (Tg) of the cellulose acetate butyrate resin used herein denotes a temperature of degree Celsius (° C.) that is converted from a temperature (degree Kelvin) obtained by calculating in accordance with the Fox theoretical equation.

The molecular weight of an acrylic polyol resin which is to be a cured acrylic polyol resin is not particularly limited. However, it is preferable that an acrylic polyol resin having a weight average molecular weight (Mw) of not less than 30000 and not more than 150000 is used. When the back face layer 5 contains an acrylic polyol resin having a weight average molecular weight (Mw) in this range, it is possible to impart sufficient heat resistance to the back face layer 5 as well as to sufficiently elicit the action of an slip agent component described below. Incidentally, the weight average molecular weight (Mw) denotes a value measured by the gel permeation chromatography (GPC) and calibrated with polystyrene standard.

The hydroxyl value of an acrylic polyol resin to obtain a cured acrylic polyol resin is not particularly limited. However, it is preferable to use an acrylic polyol resin having a hydroxyl value of not less than 10 mg KOH/g and not more than 100 mg KOH/g. According to an acrylic polyol resin having a hydroxyl value in this range, it is possible to obtain a cured acrylic polyol resin which takes an optimal cross-linked structure form by a curing agent. This structure form can impart sufficient heat resistance to the back face layer 5 as well as sufficiently elicit the action of a slip agent component described below. Herein, the term “hydroxyl value” of the acrylic polyol resin means the number in mg of potassium hydroxide required to acetylate the hydroxyl groups contained in 1 g of the acrylic polyol resin. The hydroxyl value can be determined by preparing an acrylic polyol resin pyridine solution containing acetic anhydride, acetylating the hydroxyl groups, hydrolyzing an excess of acetylation reagent by water, and subjecting obtained acetic acid to a titration with potassium hydroxide.

The molar equivalent ratio between the functional group owned by the curing agent and the hydroxyl group of the acrylic polyol resin which reacts with the functional group is not particularly limited. However, when the acrylic polyol resin is cured by the curing agent in a smaller amount of the curing agent, that is, in an amount formulated which results in a smaller molar equivalent ratio between the functional group owned by the curing agent and the hydroxyl group owned by the acrylic polyol resin, the slidability upon image formation in the halftone gradation area tends to become lower depending on the curing degree. Further, when the molar equivalent ratio is increased more than required to thereby allow the back face layer 5 to contain the unreacted curing agent in a large amount, the reservation property of the thermal transfer sheet becomes lower. When the thermal transfer sheet is wound into a small roll, blocking is prone to occur. Therefore, in forming the back face layer 5, the amount of the acrylic polyol resin and the curing agent to be formulate may be determined in consideration of these points. For example, when the back face layer 5 contains a cured acrylic polyol resin in which an acrylic polyol resin is cured by an isocyanate curing agent, it is preferable that the back face layer 5 contains a cured acrylic polyol resin which is formed by curing at a molar equivalent ratio (—NCO/—OH) between the isocyanate group owned by the isocyanate curing agent and the hydroxyl group owned by the acrylic polyol resin in the range of not less than 0.25 and not more than 1.50.

For instance, by carrying out the infrared absorption (FT-IR) analysis, it is possible to determine whether the back face layer of a thermal transfer sheet of interest contains the cured acrylic polyol resin. Concretely, by the fact that absorption(s) of acrylic acid ester or methacrylic acid ester can be observed or not on measurement of the back face layer, it can be identified that the resin contained in the back face layer is acrylic polyol resin or not. Further, in the case that an isocyanate curing agent is used as the curing agent, by the fact that absorption(s) of an urethane bond where an isocyanate group and a hydroxyl group were reacted with each other and absorption(s) of the remaining unreacted isocyanate can be observed or not, it can be identified that the resin contained in the back face layer is the cured acrylic polyol resin or not. In addition, by carrying out the infrared spectroscopy (IR) measurement to determine whether additional peak(s) which is due to the bonding to the hydroxyl group is found or not, it can be identified that the resin contained in the back face layer is the cured acrylic polyol resin or not. Moreover, in the case that it is identified that the back face layer contains the cured acrylic polyol resin by utilizing these measurements, by separately preparing an acrylic polyol resin which has the corresponding absorption(s) or peak(s), and subjecting this separately prepared acrylic polyol resin to the measurement of glass transition temperature (Tg), it is possible to determine the glass transition temperature (Tg) of the acrylic polyol resin which is to be the cured acrylic polyol resin.

The content of the cured acrylic polyol resin is not particularly limited. However, when the content of the cured acrylic polyol resin on the basis of the total mass of the back face layer 5 is less than 20% by mass, the slidability of the back face layer upon image formation in the halftone gradation area tends to decrease. On the other hand, when the content exceeds 70% by mass, there is a tendency that, accordingly, the content of a glycerin fatty acid ester or polyglycerin fatty acid ester described below decreases, and the effect of inhibiting occurrence of kicks is reduced. In consideration of this point, it is preferable that the cured acrylic polyol resin is contained in the range of not less than 20% by mass and not more than 70% by mass on the basis of the total mass of the back face layer 5.

### <Optional Binder Resin>

It is preferable that the back face layer 5 contains a cellulose acetate butyrate (CAB) resin as an optional binder resin together with a cured acrylic polyol resin. According to the back face layer 5 containing a cellulose acetate butyrate resin together with a cured acrylic polyol resin, it is possible to further enhance the effect of inhibiting occurrence of kicks, as compared with a back face layer containing singly a cured acrylic polyol resin as the binder resin and a back face layer containing a cured acrylic polyol resin and a binder resin other than cellulose acetate butyrate resins.

The content of the cellulose acetate butyrate resin is not particularly limited, and it is possible to set the content as appropriate within a range not to impair the content of the above mentioned cured acrylic polyol resin, and a glycerin fatty acid ester and a polyglycerin ester described below. It is preferable that the content is not less than 10% by mass and not more than 50% by mass on the basis of the total mass of the back face layer. Further, it is preferable that the glass transition temperature (Tg) of the cellulose acetate butyrate resin is not less than 70° C. and not more than 150° C. When the back face layer 5 contains a cellulose acetate butyrate resin having a glass transition temperature (Tg) in this range, further improvements in the heat resistance and the effect of inhibiting kicks can be expected.

Further, the back face layer 5 may contain other optional binder resin together with or instead of the above mentioned cellulose acetate butyrate resin. As other optional binder resin, for instance, polyester type resins, polyacrylic ester type resins, polyvinyl acetate type resins, styrene acrylate type resins, polyurethane type resins, polyethylene type resins, polypropylene type resins, polystyrene type resins, polyvinyl chloride type resins, polyether type resins, polyamide type resins, polyimide type resins, polyamide-imide type resins, polycarbonate type resins, polyacrylamide resins, polyvinyl chloride resins, polyvinyl butyral resins, polyvinyl acetoacetal resins, and silicone-modified forms thereof may be enumerated.

### <Glycerin Fatty Acid Ester and Polyglycerin Fatty Acid Ester>

The back face layer 5 contains a glycerin fatty acid ester or a polyglycerin fatty acid ester as the slip agent component, together with the above mentioned cured acrylic polyol resin. Hereinafter, the glycerin fatty acid ester and the polyglycerin fatty acid ester may be collectively called (poly)glycerin fatty acid esters. Further, as the slip agent component, the back face layer 5 may contain one kind of (poly)glycerin fatty acid ester singly, or may contain two or more kinds of (poly)glycerin fatty acid esters. Further, the back face layer 5 may contain both of the glycerin fatty acid ester and the polyglycerin fatty acid ester.

The (poly)glycerin fatty acid ester has poor dyeability with the color materials in the color material layers, as compared with conventionally known slip agent components, such as phosphate esters and metal soap. Therefore, According to the back face layer 5 which contains a (poly)glycerin fatty acid ester, when the thermal transfer sheet includes a color material layer provided on one surface of the substrate, and the thermal transfer sheet is wound such that the color material layer 3 and the back face layer 5 are opposed to each other, it is possible to effectively prevent occurrence of kicks, by which the dye in the color material layer 3 migrates to the back face layer 5.

In addition, the (poly)glycerin fatty acid ester excels in the slidability upon image formation in the low gradation area and the halftone gradation area, particularly in the slidability upon image formation in the low gradation area. Accordingly, it is possible to impart good slidability upon image formation in the low gradation area and the halftone gradation area to the back face layer 5, in combination with the good slidability of the above mentioned cured acrylic polyol resin.

Further, the (poly)glycerin fatty acid ester can impart good slidability upon image formation in the low gradation area to the back face layer even without a phosphate ester or the like, which is a neutral slip agent component as well as an acidic slip agent component. Therefore, when a form is made in which the back face layer 5 contains substantially no acidic slip agent component, it is possible to inhibit corrosion in the heating element of the thermal head. Incidentally, “contains substantially no acidic slip agent component” means that the content of the acidic slip agent component is less than 0.1% by mass on the basis of the total mass of the back face layer 5. Further, the acidic slip agent component used herein means a slip agent component having an acidic value of not less than 50. When the back face layer 5 contains a slip agent component having an acidic value of not less than 50, the heating element of the thermal head will be subjected to corrosion and abrasion. As the slip agent component having an acidic value of not less than 50, for instance, phosphate esters can be enumerated. In addition, the acid value means the number in mg of KOH required to neutralize all the acidic groups contained in 1 g of the slip agent component.

A glycerin fatty acid ester is an esterified product of glycerin and fatty acid. The glycerin fatty acid ester is not particularly limited, and may be any of glycerin monofatty acid esters (may be referred to as monoacylglycerol), glycerin difatty acid esters (may be referred to as diacylglycerol), and glycerin trifatty acid esters (may be referred to as triacylglycerol).

A polyglycerin fatty acid ester is an esterified product of a glycerin multimer and fatty acid. A preferable polyglycerin fatty acid ester contains 2 to 10 glycerin units in the molecule, and some of their hydroxyl groups form an ester with the fatty acid.

As the fatty acid residue in the (poly)glycerin fatty acid ester, lauric acid residues, palmitic acid residues, stearic acid residues, isostearic acid residues, oleic acid residues, caprylic acid residues, myristic acid residues, behenic acid residues and the like can be enumerated. Further, the (poly)glycerin fatty acid ester may include different fatty acid residues in a molecule.

As concrete examples of the glycerin fatty acid ester, glycerol monolaurate, glycerol monopalmitate, glycerol monooleate, glycerol monostearate, glycerol monobehenate, glycerol monocaprylate, glycerol monomyristate, glycerol dilaurate, glycerol dipalmitate, glycerol dioleate, glycerol distearate, glycerol dibehenate, glycerol dicaprylate, glycerol dimyristate, glycerol trilaurate, glycerol tripalmitate, glycerol trioleate, glycerol tristearate, glycerol tribehenate, glycerol tricaprylate, glycerol trimyristate, and the like can be enumerated.

As concrete examples of the polyglycerin fatty acid ester, diglycerin triisostearate, diglycerin tetraisostearate, tetraglycerin pentaoleate, hexaglycerin pentaoleate, decaglycerin nonaisostearate, decaglycerin decaoleate, decaglycerin octaerucate, decaglycerin heptaoleate, and the like can be enumerated.

It is preferable that the back face layer 5 contains a (poly)glycerin fatty acid ester having a melting point of not more than 25° C. According to the back face layer 5 which contains a (poly)glycerin fatty acid ester having a melting point of not more than 25° C., it is possible to allow the (poly)glycerin fatty acid ester to be in the liquid state in the back face layer 5 at atmospheric temperature and to improve the smoothness of the back face layer 5. When the smoothness of the back face layer 5 is improved, it is possible to provide good gloss of a printed article which can be obtained by using the thermal transfer sheet. Incidentally, the melting point of the (poly)glycerin fatty acid ester is a melting point measured in compliant to JIS K0064 (1992). This is also applicable to the melting point of a solid slip agent described below.

As the (poly)glycerin fatty acid ester having a melting point of not more than 25° C., for example, glycerol trioleate, glycerol tricaprylate, glycerol tri(oleate/palmitate/stearate), and glycerol tri(caprylate/caprate) can be enumerated. Diglycerin triisostearate, diglycerin tetraisostearate, tetraglycerin pentaoleate, hexaglycerin pentaoleate, decaglycerin nonaisostearate, decaglycerin decaoleate, decaglycerin octaerucate, decaglycerin heptaoleate, and the like can be enumerated.

Further, when fatty acid residues contained in the (poly)glycerin fatty acid ester have a longer carbon chain, the slidability of the back face layer and the effect of inhibiting occurrence of kicks tend to increase, as compared with a (poly)glycerin fatty acid ester which contains fatty acid residues having a shorter carbon chain. Therefore, it is preferable that the (poly) glycerin fatty acid ester contained in the back face layer 5 contains fatty acid residue having a longer carbon chain, and concretely, it is preferable that the (poly)glycerin fatty acid ester contains fatty acid residues having a carbon chain length of not less than 18. More concretely, it is preferable that the (poly)glycerin fatty acid ester contains, as the fatty acid residues, stearic acid residues, isostearic acid residues, oleic acid residues, erucic acid, and the like.

The content of the (poly)glycerin fatty acid ester is not particularly limited. However, when the (sum) mass of the (poly)glycerin fatty acid ester on the basis of the total mass of the back face layer 5 is less than 2% by mass, the slidability of the back face layer upon image formation in the low gradation area tends to be reduced. In contrast, when the content exceeds 20% by mass, the slidability of the back face layer upon image formation in the low gradation area and the effect of inhibiting kicks are not expected to be further improved. Also, accordingly, the content of the above mentioned specific acrylic polyol resin becomes lower, and the slidability of the back face layer upon image formation in the halftone gradation area tends to be reduced. Therefore, in consideration of this point, it is preferable that the back face layer 5 contains the (poly)glycerin fatty acid ester in the range of not less than 2% by mass and not more than 20% by mass on the basis of the total mass of the back face layer 5.

Further, the back face layer 5 may contain other optional slip agent as a slip agent component, together with the (poly)glycerin fatty acid ester. As the other slip agent component, metal soaps, fatty acid amides, which are fatty acid derivatives, graphite powder, fluorine graft polymers, silicone oils, silicone graft polymers, acrylic silicone graft polymers, silicone polymers such as acrylic siloxanes and aryl siloxanes, polyethylene wax, and the like can be enumerated.

Particularly, it is preferable that the back face layer 5 contains a solid slip agent having a melting point of not less than 80° C. as other optional slip agent. When the back face layer 5 contains a solid slip agent having a melting point of not less than 80° C. together with the (poly)glycerin fatty acid ester, it is possible to provide good slidability of the back face layer 5 on image formation not only in the low gradation area and the halftone gradation area but also in the high gradation area.

As the solid slip agent having a melting point of not less than 80° C., metal soaps, fatty acid amides, which are fatty acid derivatives, and the like are preferred. As these metal soaps, for example, polyvalent metal salts of alkylphosphate esters, polyvalent metal salts of fatty acids, metal salts of alkylcarboxylic acids, more concretely, zinc stearyl phosphate, and zinc stearate can be enumerated. As the fatty acid amide, ethylene bis-oleic acid amide, methylene bis-stearic acid amide, stearic acid amide, and the like can be enumerated.

Although these solid slip agents can be expected to achieve the effect of improving slidability of the back face layer 5, the slip agents are apt to be dyed with the color material in the color material layer, as compared with (poly)glycerin fatty acid esters. When the content of the solid slip agent having a melting point of not less than 80° C. exceeds 8% by mass on the basis of the total mass of the back face layer 5, the effect of inhibiting occurrence of kicks tends to be reduced. Further, the smoothness of the back face layer 5 becomes lower, and the gloss of a printed article which can be obtained by using the thermal transfer sheet tends to be reduced. Therefore, in consideration of this point, it is preferable that the content of the solid slip agent having a melting point of not less than 80° C. on the basis of the total mass of the back face layer 5 is not more than 8% by mass, and it is also preferable that, from the viewpoint of the slidability of the back face layer upon image formation in the high gradation area, the content is not less than 1% by mass.

The method for forming the back face layer 5 is not particularly limited. The back face layer 5 can be formed by preparing a coating liquid for the back face layer where a cured acrylic polyol resin, which is the essential component, a (poly)glycerin fatty acid ester, other binders added as necessary, and a slip agent component are dispersed or dissolved in an appropriate solvent, coating thus prepared coating liquid for the back face layer on the substrate 1 in accordance with a known coating procedure such as the gravure printing method, the screen printing method, and the reverse roll coating printing method using a gravure plate, and then drying the coated solution. With respect to the amount coated on the back face layer 5, from the viewpoint of the improvement in the heat resistance and the like, the amount coated after drying is preferably not more than 3 g/m², more preferably from 0.1 to 2 g/m².

### (Back Face Primer Layer)

Further, a back face primer layer, not shown, may be provided between the substrate 1 and the back face layer 5 in order to improve the adhesiveness between the substrate 1 and the back face layer 5. As the material of the back face primer layer, materials that exhibit adhesiveness, such as polyester resins, and acrylic resins can be enumerated.

### (Color Material Layer)

As shown in FIGS. 1 to 3, a color material layer 3 and/or a protective layer 4 is provided on at least a part of one surface of the substrate 1. In the present invention, the layer is not limited to the embodiment shown in the figures, and may be in embodiments other than those shown. For example, a color material layer 3 which contains sublimable dye and a color material layer 3 which contains heat-fusion ink comprising a heat-fusion composition containing a coloring agent may be frame-sequentially provided on one continuous substrate. Incidentally, in the prevent invention, either one of the color material layer 3 or the protective layer 4 should be provided on one surface of the substrate 1. When the protective layer 4 is provided, the color material layer 3 will be an optional component.

When the thermal transfer sheet of the present invention is a sublimation type thermal transfer sheet, this color material layer 3 is a color material layer containing sublimable dye. In contrast, when the thermal transfer sheet is a heat-fusion type thermal transfer sheet, the color material layer will be a color material layer which contains heat-fusion ink comprising a heat-fusion composition containing a coloring agent. Hereinafter, the case of the sublimation type thermal transfer sheet will be mainly described, but the present invention is not limited to the sublimation type thermal transfer sheet.

Incidentally, in the present invention, since the polyglycerin fatty acid ester satisfying the above mentioned condition 2 and condition 3 imparts sufficient slidability to the back face layer 5, relatively high energy is applied on image formation. Thus, the back face layer 5 can be suitably used as the back face layer 5 of the sublimation type thermal transfer sheet, in which good slidability is required for the back face layer 5.

As the materials of the color material layer, conventionally known dyes can be used, but those having good properties as printing materials, for examples, those having a sufficient coloring density and exhibiting no discoloration and fading by light, heat, temperature and the like are preferred. Diarylmethane dyes; triarylmethane dyes; thiazole dyes; merocyanine dyes; pyrazolone dyes; methine dyes; indoaniline dyes; azomethine dyes such as acetophenone azomethine dyes, pyrazolo azomethine dyes, imidazol azomethine dyes, imidazo azomethine dyes, and pyridone azomethine dyes; xanthene dyes; oxazine dyes; cyanostyrene dyes such as dicyanostyrene dyes and tricyanostyrene dyes; thiazine dyes; azine dyes; acridine dyes; benzeneazo dyes; azo dyes such as, pyridoneazo dyes, thiopheneazo dyes, isothiazoleazo dyes, pyrroleazo dyes, pyrazoleazo dyes, imidazoleazo dyes, thiadiazoleazo dyes, triazoleazo dyes, and disazo dyes; spiropyran dyes; indolinospiropyran dyes; fluoran dyes; rhodaminelactam dyes; naphthoquinone dyes; anthraquinone dyes; and quinophthalone dyes, and the like can be enumerated. Concretely, red dyes, such as Disperse Red 60, Disperse Violet 26, Ceres Red 7B, and Samaron Red F3BS; yellow dyes, such as Disperse Yellow 231, PTY-52, and Macrolex Yellow 6G; blue dyes, such as Solvent Blue 63, Waxoline Blue AP-FW, Foron Brilliant Blue S-R, MS Blue 100, and C.I. Solvent Blue 22; and the like can be enumerated.

As the binder resin for supporting such a dye, for instance, cellulosic resins such as ethylcellulose resins, hydroxyethylcellulose resins, ethylhydroxycellose resins, methylcellulose resins, and cellulose acetate resin; vinyl resins such as polyvinylalcohol resins, polyvinyl acetate resins, polyvinylbutyral resins, polyvinylacetal resins, and polyvinylpyrrolidone; acrylic resins such as poly(meth)acrylate and poly(meta)acrylamide; polyurethane resins, polyamide resins, polyester resins can be enumerated. Among them, resins such as cellulosic, vinyl, acrylic, polyurethane, and polyester are preferable in the points of heat resistance, dye-transfer efficiency and the like.

The color material layer 3 may contain additives, such as inorganic fine particles, and organic fine particles. Examples of the inorganic fine particles include carbon black, silica, alumina, titanium dioxide, and molybdenum disulfide, and examples of the organic fine particles include polyethylene waxes. Further, the color material layer 3 may contain a release agent. Examples of the release agent include silicone oils, phosphate esters, and fluorine materials. Further, the color material layer 3 may contain various curing agents, such as isocyanates, epoxy resins, and carbodiimide.

In contrast, when the thermal transfer sheet 10 of the present invention is a heat-fusion type thermal transfer sheet, the color material layer 3 contains heat-fusion type ink and a binder resin in addition to the polyglycerin fatty acid ester. The heat-fusion type ink can be appropriately selected from known organic or inorganic pigments or dyes. For example, those having a sufficient coloring density and exhibiting no discoloration and fading by light, heat, and the like are preferred. The color of the heat-fusion type ink is not limited to cyan, magenta, yellow, and black, and coloring agents of various colors can be used.

As the binder resin contained in the color material layer 3 of the heat-fusion type thermal transfer sheet, for example, ethylene-vinyl acetate copolymers, ethylene-acrylic ester copolymers, polyethylene, polystyrene, polypropylene, polybutene, petroleum resins, vinyl chloride resins, vinyl chloride-vinyl acetate copolymers, polyvinylalcohol, vinylidene chloride resins, acrylic resins, methacrylic resins, polyamides, polycarbonates, fluorine resins, polyvinyl formal, polyvinyl butyral, acetyl cellulose, nitrocellulose, polyvinyl acetate, polyisobutylene, ethyl cellulose, or polyacetal can be used.

The content of the sublimable dye or pigment contained in the color material layer is not particularly limited, and may be determined as appropriate, in consideration of the print density and reservation property, depending on the type of the sublimable dye or pigment used and the type of binder resin. For example, it is preferable that the sublimable dye is contained in the color material layer 3 within the range of not less than 15% by mass and not more than 300% by mass on the basis of the total mass of the binder resin contained in the color material layer 3.

Further, the heat-fusion type color material layer 3 may contain microcrystalline wax, carnauba wax, paraffin wax, or the like. Furthermore, wax components, such as Fischer-Tropsch wax, various low molecular weight polyethylenes, Japan wax, bee wax, spermaceti, insect wax, wool wax, shellac wax, candelilla wax, petrolatum, polyester wax, partially-modified wax, fatty acid ester, and fatty acid amide may be contained.

With respect to the method for forming the color material layer 3, the color material layer 3 can be formed by preparing a coating liquid where a dye or pigment and various additives added as required are added to an appropriate binder resin, and dispersed or dissolved in an appropriate solvent such as toluene, methyl ethyl ketone, ethanol, isopropyl alcohol, cyclohexane, dimethylformamide, and water, coating the thus prepared coating liquid on the substrate 1 or on any layer provided on the substrate by a forming procedure, for example, the gravure printing method, the reverse roll coating method using a gravure plate, a roll coater, a bar-coater or the like, and then drying the coated solution.

### (Protective Layer)

As shown in FIG. 2, a protective layer 4 can be provided entirely on the substrate 1. As shown in FIG. 3, in the thermal transfer sheet 10 of the present invention, the above mentioned color material layer 3 and protective layer 4 can be frame-sequentially provided on the substrate 1. As mentioned above, either one of the color material layer 3 or the protective layer 4 should be provided on one surface of the substrate 1. When the color material layer 3 is provided on the substrate 1, the protective layer 4 will be an optional layer.

The protective layer 4 may be in a multi-layer structure or in a single-layer structure. In the case of the multi-layer structure, the protective layer may contain an adhesive layer, which is placed on the outermost surface of the protective layer 4 to increase the adhesiveness between the protective layer 4 and the receiving surface of a printed article, an auxiliary protective layer, a layer to add functions other than those of the protective layer itself, and the like, in addition to the main protective layer, which is the main body to impart various resistant properties to images. The main protective layer and the other layers may be placed in any order, but usually, the other layers are placed between the adhesive layer and the main protective layer such that the main protective layer will be the outermost layer of the receiving surface after transfer.

The main protective layer, which constitutes the protective layer 4 of the multi-layer structure, or the protective layer 4 of the single-layer structure can be formed with various resins which are conventionally known resins for forming a protective layer. As the resin for forming a protective layer, for example, polyester resins, polystyrene resins, acrylic resins, polyurethane resins, acrylic urethane resins, silicone-modified forms of these resins, mixtures of any combination of these resins, ionizing radiation-curable resins, and ultraviolet shielding resins can be exemplified.

A protective layer containing an ionizing radiation-curable resin excels particularly in plasticizer resistance and abrasion resistance. As the ionizing radiation-curable resin, those known can be used. For example, it is possible to use resins prepared by crosslinking and curing radical polymerizable polymer or oligomer by ionizing radiation, adding a photopolymerization initiator as required, and polymerizing and crosslinking the polymer or oligomer by an electron beam or ultraviolet ray.

A protective layer containing an ultraviolet shielding resin is mainly intended to impart light resistance to printed articles. As the ultraviolet shielding resin, for instance, a resin which is prepared by reacting and linking a reactive ultraviolet absorbing agent to a thermoplastic resin or the ionizing radiation-curable resin mentioned above can be used. More concretely, those prepared by introducing a reactive group such as an addition-polymerizable double bond (for instance, vinyl group, acryloyl group, methacryloyl group, etc.), alcoholic hydroxyl group, amino group, carboxyl group, epoxy group, and isocyanate group into a non-reactive organic ultraviolet absorbing agent conventionally known in the art such as salicylate series, benzophenone series, benzotriazole series, substituted acrylonitrile series, nickel-chelate series, and hindered amine series can be exemplified.

It is preferable that the protective layer 4 of the single-layer structure or the main protective layer provided in the protective layer 4 of the multi-layer structure usually has a thickness of the order of 0.5 to 10 μm although the thickness depends on the type of the resin for forming the protective layer.

The adhesive layer may be formed on the outermost surface of the protective layer 4. The adhesive layer can be formed with a resin having good adhesion on heating, for example, acrylic resins, vinyl chloride type resins, vinyl acetate type resins, vinyl chloride/vinyl acetate copolymer resins, polyester type resins, and polyamide type resins. The thickness of the adhesive layer is usually of the order of 0.1 to 5 μm. Further, a release layer may be provided between the protective layer 4 and the substrate.

### (Under Coating Layer)

In the present invention, it is preferable that a under coating layer, not shown, is provided between the substrate 1 and the color material layer 3. When an under coating layer is provided, it is possible to improve the adhesiveness between the substrate 1 and the color material layer 3 and to prevent abnormal transfer of the color material layer 3 onto a thermal transfer receiving sheet on thermal transfer. Incidentally, the under coating layer is an optional component in the thermal transfer sheet 10.

As resin for constituting the under coating layer, polyester type resins, polyacrylic ester type resins, polyvinyl acetate type resins, polyurethane type resins, styrene acrylate type resins, polyacrylamide type resins, polyamide type resins, polyether type resins, polystyrene type resin, polyethylene type resins, polypropylene type resins, vinyl type resins such as polyvinyl chloride type resins and polyvinylalcohol resins, polyvinyl acetal type resins such as polyvinyl acetoacetal, polyvinyl butyral, and the like can be enumerated.

Further, the under coating layer can be constituted from colloidal inorganic pigment ultrafine particles. Thereby it is possible not only to prevent abnormal transfer of the color material layer 3 on image formation, but also to prevent migration of the color material from the color material layer 3 to the under coating layer. This allows the color material to effectively diffuse on the receiving layer side of the thermal transfer receiving sheet to thereby increase the print density.

As the colloidal inorganic pigment ultrafine particles, conventionally known compounds can be used. For example, silica (colloidal silica), alumina or alumina hydrates (alumina sols, colloidal alumina, cationic aluminum oxide or hydrates thereof, pseudo-boehmite, and the like), aluminum silicate, magnesium silicate, magnesium carbonate, magnesium oxide, and titanium oxide can be enumerated. In particular, colloidal silica and alumina sols are preferably used. These colloidal inorganic pigment ultrafine particles have a primary average particle size of not more than 100 nm, preferably not more than 50 nm. In particular, it is preferable to use such particles having a primary average particles size of 3 to 30 nm.

The under coating layer can be formed by preparing a coating liquid for the under coating layer where the resin exemplified above and colloidal inorganic pigment ultrafine particles are dissolved or dispersed in an appropriate solvent, coating thus prepared coating liquid for the under coating layer in accordance with a conventionally known forming procedure such as the gravure coating method, the roll coating method, the screen printing method, and the reverse roll coating method using a gravure plate, and then drying the coated solution. The amount of the coating liquid for the under coating layer coated is preferably of the order of 0.02 to 1.0 g/m².

### EXAMPLES

Next, the present invention will be described more concretely with demonstrating examples. Hereinafter, unless otherwise indicated, “part” and “%” are on the basis of the mass. Further, unless otherwise indicated, “part” and “%” refer to the solid content.

### Example 1

As a substrate, a long polyethylene terephthalate film which underwent easy-adhesive treatment and had a thickness of 5 μm was prepared. To one entire surface of this substrate, a coating liquid for the back face layer 1 having the following composition was applied so as to achieve an amount of 0.8 g/m² in the dried state to form a back face layer. Then, to the other entire surface of the substrate a coating liquid for the under coating layer having the following composition was applied to achieve an amount coated in the dried state of 0.1 g/m² and dried to form an under coating layer, resulting in a laminate in which the back face layer, the substrate, and the under coating layer were laminated in this order. Onto the under coating layer of this laminate, each of a coating liquid for the yellow dye layer, a coating liquid for the magenta dye layer, and a coating liquid for the cyan dye layer was applied so as to achieve the amount coated in the dried state of 0.6 g/m² to form a yellow dye layer (Y dye layer), a magenta dye layer (M dye layer), and a cyan dye layer (C dye layer) frame-sequentially on the laminate to thereby produce the thermal transfer sheet of Example 1.

### Coating Liquid for Back Face Layer 1

Molar equivalent ratio (—NCO/—OH): 1.0

| | |
|---|---|
| Acrylic polyol resin (solid content: | 76.5 parts |
| 40%, Tg: 98° C., Mw: 23000, | |
| Hydroxyl value (solid): 60 —OH: 24) | |
| (Q167-40, manufactured by Mitsui Chemicals Co., Ltd.) | |
| Isocyanate type curing agent | 16 parts |
| (solid content: 75% —NCO: 11.5%) | |
| (TAKENATE D110N (XDI type), manufactured by | |
| Mitsui Chemicals Co., Ltd.) | |
| Glycerol tri(oleate/palmitate/stearate) (95/4/1) | 5 parts |
| (ACTOR LO-1 (melting point 5° C.), manufactured by | |
| RIKEN VITAMIN Co., Ltd.) | |
| Talc | 2.5 parts |
| (MICRO ACE P3, manufactured by Nippon Talc Co., Ltd.) | |
| Methyl ethyl ketone | 75 parts |
| Toluene | 75 parts |

### <Coating Liquid for Under Coating Layer>

| | |
|---|---|
| Colloidal silica (particle size 4 to | 30 parts |
| 6 nm, solid content 10%) | |
| (SNOWTEX OXS, manufactured by Nissan | |
| Chemical Industries, Ltd.) | |
| Polyvinylpyrrolidone resin (K-90, manufactured by | 3 parts |
| ISP Co., Ltd.) | |
| Water | 50 parts |
| Isopropyl alcohol | 17 parts |

### <Coating Liquid for Yellow Dye Layer>

| | |
|---|---|
| Solvent Yellow 93 | 2.0 parts |
| Disperse Yellow 231 | 2.0 parts |
| Polyvinyl acetal resin | 3.5 parts |
| (S-LEC KS-5, manufactured by Sekisui | |
| Chemical Co., Ltd.) | |
| Polyethylene wax | 0.1 parts |
| Methyl ethyl ketone | 45.0 parts |
| Toluene | 45.0 parts |

### <Coating Liquid for Magenta Dye Layer>

| | |
|---|---|
| Disperse dye (MS Red G) | 1.5 parts |
| Disperse dye (Macrolex Red violet R) | 2.0 parts |
| Polyvinyl acetal resin | 4.5 parts |
| (S-LEC KS-5, manufactured by Sekisui | |
| Chemical Co., Ltd.) | |
| Polyethylene wax | 0.1 parts |
| Methyl ethyl ketone | 45.0 parts |
| Toluene | 45.0 parts |

### <Coating Liquid for Cyan Dye Layer>

| | |
|---|---|
| Solvent Blue 63 | 2.0 parts |
| Disperse Blue 354 | 2.0 parts |
| Polyvinyl acetal resin | 3.5 parts |
| (S-LEC KS-5, manufactured by Sekisui | |
| Chemical Co., Ltd.) | |
| Polyethylene wax | 0.1 parts |
| Methyl ethyl ketone | 45.0 parts |
| Toluene | 45.0 parts |

### Example 2

The same procedure as described in Example 1 was repeated, except for replacing the coating liquid for back face layer 1 with a coating liquid for back face layer 2 having the following composition to prepare a thermal transfer sheet of Example 2.

### Coating Liquid for Back Face Layer 2

Molar equivalent ratio (—NCO/—OH): 1.0

| | |
|---|---|
| acrylic polyol resin (solid content: | 76.5 parts |
| 40%, Tg: 98° C., Mw: 23000, | |
| Hydroxyl value (solid): 60 —OH: 24) | |
| (Q167-40, manufactured by Mitsui Chemicals Co., Ltd.) | |
| Isocyanate type curing agent | 16 parts |
| (solid content: 75% —NCO: 11.5%) | |
| (TAKENATE D110N (XDI type), manufactured by | |
| Mitsui Chemicals Co., Ltd.) | |
| Diglycerin triisostearate | 5 parts |
| (NIKKOL DGTIS (melting point not more than −6.2° C.), | |
| manufactured by Nikko Chemicals Co., Ltd.) | |
| Talc | 2.5 parts |
| (MICRO ACE P3, manufactured by Nippon Talc Co., Ltd.) | |
| Methyl ethyl ketone | 75 parts |
| Toluene | 75 parts |

### Example 3

The same procedure as described in Example 1 was repeated, except for replacing the coating liquid for back face layer 1 with a coating liquid for back face layer 3 having the following composition to prepare a thermal transfer sheet of Example 3.

### Coating Liquid for Back Face Layer 3

Molar equivalent ratio (—NCO/—OH): 0.5

| | |
|---|---|
| Acrylic polyol resin (solid content: | 84.1 parts |
| 40%, Tg: 98° C., Mw: 23000, | |
| Hydroxyl value (solid): 60 —OH: 24) | |
| (Q167-40, manufactured by Mitsui Chemicals Co., Ltd.) | |
| Isocyanate type curing agent | 8.8 parts |
| (solid content: 75% —NCO: 11.5%) | |
| (TAKENATE D110N (XDI type), manufactured by | |
| Mitsui Chemicals Co., Ltd.) | |
| Glyceryl tri(oleate/palrnitate/stearate) (95/4/1) | 4.7 parts |
| (ACTOR LO-1 (melting point 5° C.), manufactured by | |
| RIKEN VITAMIN Co., Ltd.) | |
| Talc | 2.4 parts |
| (MICRO ACE P3, manufactured by Nippon Talc Co., Ltd.) | |
| Methyl ethyl ketone | 68.3 parts |
| Toluene | 68.3 parts |

### Example 4

The same procedure as described in Example 1 was repeated, except for replacing the coating liquid for back face layer 1 with a coating liquid for back face layer 4 having the following composition to prepare a thermal transfer sheet of Example 4.

### Coating Liquid for Back Face Layer 4

Molar equivalent ratio (—NCO/—OH): 1.0

| | |
|---|---|
| Acrylic polyol resin (solid content: | 63.2 parts |
| 35%, Tg: 110° C., Mw: 83000, —OH: 45) | |
| Isocyanate type curing agent | 29 parts |
| (solid content: 75% —NCO: 11.5%) | |
| (TAKENATE D110N (XDI type), manufactured by | |
| Mitsui Chemicals Co., Ltd.) | |
| Glyceryl tri(oleate/palmitate/stearate) (95/4/1) | 5.2 parts |
| (ACTOR LO-1 (melting point 5° C.), manufactured by | |
| RIKEN VITAMIN Co., Ltd.) | |
| Talc | 2.6 parts |
| (MICRO ACE P3, manufactured by Nippon Talc Co., Ltd.) | |
| Methyl ethyl ketone | 79 parts |
| Toluene | 79 parts |

### Example 5

The same procedure as described in Example 1 was repeated, except for replacing the coating liquid for back face layer 1 with a coating liquid for back face layer 5 having the following composition to prepare a thermal transfer sheet of Example 5.

### Coating Liquid for Back Face Layer 5

Molar equivalent ratio (—NCO/—OH): 1.0

| | |
|---|---|
| Acrylic polyol resin (solid content: | 61.2 parts |
| 25%, Tg: 158° C., Mw: 90000, —OH: 60 | |
| Isocyanate type curing agent | 31.9 parts |
| (solid content: 75% —NCO: 11.5%) | |
| (TAKENATE D110N (XDI type), manufactured by | |
| Mitsui Chemicals Co., Ltd.) | |
| Glyceryl tri(oleate/palmitate/stearate) (95/4/1) | 4.6 parts |
| (ACTOR LO-1 (melting point 5° C.), manufactured by | |
| RIKEN VITAMIN Co., Ltd.) | |
| Talc | 2.3 parts |
| (MICRO ACE P3, manufactured by Nippon Talc Co., Ltd.) | |
| Methyl ethyl ketone | 65 parts |
| Toluene | 65 parts |

### Example 6

The same procedure as described in Example 1 was repeated, except for replacing the coating liquid for back face layer 1 with a coating liquid for back face layer 6 having the following composition to prepare a thermal transfer sheet of Example 6.

### Coating Liquid for Back Face Layer 6

Molar equivalent ratio (—NCO/—OH): 1.0

| | |
|---|---|
| Acrylic polyol resin (solid content: | 71.7 parts |
| 40%, Tg: 98° C., Mw: 23000, | |
| Hydroxyl value (solid): 60 —OH: 24) | |
| (Q167-40, manufactured by Mitsui Chemicals Co., Ltd.) | |
| Isocyanate type curing agent | 15 parts |
| (solid content: 75% —NCO: 11.5%) | |
| (TAKENATE D110N (XDI type), manufactured by | |
| Mitsui Chemicals Co., Ltd.) | |
| Glyceryl tri(oleate/palmitate/stearate) (95/4/1) | 5.3 parts |
| (ACTOR LO-1 (melting point 5° C.), manufactured by | |
| RIKEN VITAMIN Co., Ltd.) | |
| Cellulose acetate butyrate resin | 5.3 parts |
| (CAB-551-0.2, manufactured by Eastman | |
| Chemical Japan Ltd.) | |
| Talc | 2.7 parts |
| (MICRO ACE P3, manufactured by Nippon Talc Co., Ltd.) | |
| Methyl ethyl ketone | 83 parts |
| Toluene | 83 parts |

### Example 7

The same procedure as described in Example 1 was repeated, except for replacing the coating liquid for back face layer 1 with a coating liquid for back face layer 7 having the following composition to prepare a thermal transfer sheet of Example 7.

### Coating Liquid for Back Face Layer 7

Molar equivalent ratio (—NCO/—OH): 1.0

| | |
|---|---|
| Acrylic polyol resin (solid content: | 76.5 parts |
| 40%, Tg: 98° C., Mw: 23000, | |
| Hydroxyl value (solid): 60 —OH: 24) | |
| (Q167-40, manufactured by Mitsui Chemicals Co., Ltd.) | |
| Isocyanate type curing agent | 16 parts |
| (solid content: 75% —NCO: 11.5%) | |
| (TAKENATE D110N (XDI type), manufactured by | |
| Mitsui Chemicals Co., Ltd.) | |
| Decaglyceryl decastearate (wax-like solid at 25° C.) | 5 parts |
| (NIKKOL Decaglyn10-SV, manufactured by | |
| Nikko Chemicals Co., Ltd.) | |
| Talc | 2.5 parts |
| (MICRO ACE P3, manufactured by Nippon Talc Co., Ltd.) | |
| Methyl ethyl ketone | 75 parts |
| Toluene | 75 parts |

### Example 8

The same procedure as described in Example 1 was repeated, except for replacing the coating liquid for back face layer 1 with a coating liquid for back face layer 8 having the following composition to prepare a thermal transfer sheet of Example 8.

### Coating Liquid for Back Face Layer 8

Molar equivalent ratio (—NCO/—OH): 1.0

| | |
|---|---|
| Acrylic polyol resin (solid content: | 78.7 parts |
| 40%, Tg: 98° C., Mw: 23000, | |
| Hydroxyl value (solid): 60 —OH: 24) | |
| (Q167-40, manufactured by Mitsui Chemicals Co., Ltd.) | |
| Isocyanate type curing agent | 16.5 parts |
| (solid content: 75% —NCO: 11.5%) | |
| (TAKENATE D110N (XDI type), manufactured by | |
| Mitsui Chemicals Co., Ltd.) | |
| Glyceryl tri(oleate/palmitate/stearate) (95/4/1) | 2.4 parts |
| (ACTOR LO-1 (melting point 5° C.), manufactured by | |
| RIKEN VITAMIN Co., Ltd.) | |
| Talc | 2.4 parts |
| (MICRO ACE P3, manufactured by Nippon Talc Co., Ltd.) | |
| Methyl ethyl ketone | 71 parts |
| Toluene | 71 parts |

### Example 9

The same procedure as described in Example 1 was repeated, except for replacing the coating liquid for back face layer 1 with a coating liquid for back face layer 9 having the following composition to prepare a thermal transfer sheet of Example 9.

### Coating Liquid for Back Face Layer 9

Molar equivalent ratio (—NCO/—OH): 1.0

| | |
|---|---|
| Acrylic polyol resin (solid content: | 71.7 parts |
| 40%, Tg: 98° C., Mw: 23000, | |
| Hydroxyl value (solid): 60 —OH: 24) | |
| (Q167-40, manufactured by Mitsui Chemicals Co., Ltd.) | |
| Isocyanate type curing agent | 15 parts |
| (solid content: 75% —NCO: 11.5%) | |
| (TAKENATE D110N (XDI type), manufactured by | |
| Mitsui Chemicals Co., Ltd.) | |
| Glyceryl tri(oleate/palmitate/stearate) (95/4/1) | 5.3 parts |
| (ACTOR LO-1 (melting point 5° C.), manufactured by | |
| RIKEN VITAMIN Co., Ltd.) | |
| Cellulose acetate propionate resin | 5.3 parts |
| (CAP-482-0.5, manufactured by Eastman | |
| Chemical Japan Ltd.) | |
| Talc | 2.7 parts |
| (MICRO ACE P3, manufactured by Nippon Talc Co., Ltd.) | |
| Methyl ethyl ketone | 83 parts |
| Toluene | 83 parts |

### Example 10

The same procedure as described in Example 1 was repeated, except for replacing the coating liquid for back face layer 1 with a coating liquid for back face layer 10 having the following composition to prepare a thermal transfer sheet of Example 10.

### Coating Liquid for Back Face Layer 10

Molar equivalent ratio (—NCO/—OH): 1.0

| | |
|---|---|
| Acrylic polyol resin (solid content: | 69 parts |
| 45.5 ± 1.5%, Tg: 75° C. | |
| (6BT-307, manufactured by Taisei Fine | |
| Chemicals Co., Ltd.) | |
| Isocyanate type curing agent | 16.3 parts |
| (solid content: 75% —NCO: 11.5%) | |
| (TAKENATE D110N (XDI type), manufactured by | |
| Mitsui Chemicals Co., Ltd.) | |
| Glyceryl tri(oleate/palmitate/stearate) (95/4/1) | 5.8 parts |
| (ACTOR LO-1 (melting point 5° C.), manufactured by | |
| RIKEN VITAMIN Co., Ltd.) | |
| Cellulose acetate butyrate resin | 5.8 parts |
| (CAB-551-0.2, manufactured by Eastman | |
| Chemical Japan Ltd.) | |
| Talc | 2.9 parts |
| (MICRO ACE P3, manufactured by Nippon Talc Co., Ltd.) | |
| Methyl ethyl ketone | 95 parts |
| Toluene | 95 parts |

### Comparative Example 1

The same procedure as described in Example 1 was repeated, except for replacing the coating liquid for back face layer 1 with a coating liquid for back face layer A having the following composition to prepare a thermal transfer sheet of Comparative Example 1.

### <Coating Liquid for Back Face Layer A>

Molar equivalent ratio (—NCO/—OH): 1.0

| | |
|---|---|
| Polyvinyl acetal resin (Tg: 107° C.) | 59.1 parts |
| (S-LEC KS-1, manufactured by Sekisui Chemical Co., Ltd.) | |
| Isocyanate type curing agent | 32.3 parts |
| (solid content: 75% —NCO: 11.5%) | |
| (TAKENATE D110N (XDI type), manufactured by | |
| Mitsui Chemicals Co., Ltd.) | |
| Glyceryl tri(oleate/palmitate/stearate) (95/4/1) | 5.7 parts |
| (ACTOR LO-1 (melting point 5° C.), manufactured by | |
| RIKEN VITAMIN Co., Ltd.) | |
| Talc | 2.9 parts |
| (MICRO ACE P3, manufactured by Nippon Talc Co., Ltd.) | |
| Methyl ethyl ketone | 57 parts |
| Toluene | 57 parts |

### Comparative Example 2

The same procedure as described in Example 1 was repeated, except for replacing the coating liquid for back face layer 1 with a coating liquid for back face layer B having the following composition to prepare a thermal transfer sheet of Comparative Example 2.

### <Coating Liquid for Back Face Layer B>

Molar equivalent ratio (—NCO/—OH): 1.0

| | |
|---|---|
| Polyvinyl butyral resin (Tg: 71° C.) | 45.9 parts |
| (S-LEC BH-3, manufactured by Sekisui Chemical Co., Ltd.) | |
| Isocyanate type curing agent | 43.9 parts |
| (solid content: 75% —NCO: 11.5%) | |
| (TAKENATE D110N (XDI type), manufactured by | |
| Mitsui Chemicals Co., Ltd.) | |
| Glyceryl tri(oleate/palmitate/stearate) (95/4/1) | 6.8 parts |
| (ACTOR LO-1 (melting point 5° C.), manufactured by | |
| RIKEN VITAMIN Co., Ltd.) | |
| Talc | 3.4 parts |
| (MICRO ACE P3, manufactured by Nippon Talc Co., Ltd.) | |
| Methyl ethyl ketone | 77 parts |
| Toluene | 77 parts |

### Comparative Example 3

The same procedure as described in Example 1 was repeated, except for replacing the coating liquid for back face layer 1 with a coating liquid for back face layer C having the following composition to prepare a thermal transfer sheet of Comparative Example 3.

### <Coating Liquid for Back Face Layer C>

Molar equivalent ratio (—NCO/—OH): 1.0

| | |
|---|---|
| Acrylic polyol resin (solid content: | 76.5 parts |
| 40%, Tg: 98° C., Mw: 23000, | |
| Hydroxyl value (solid): 60 —OH: 24) | |
| (Q167-40, manufactured by Mitsui Chemicals Co., Ltd.) | |
| Isocyanate type curing agent | 16 parts |
| (solid content: 75% —NCO: 11.5%) | |
| (TAKENATE D110N (XDI type), manufactured by | |
| Mitsui Chemicals Co., Ltd.) | |
| Phosphate ester (melting point 15° C.) | 5 parts |
| (PLYSURF A208N, manufactured by DKS Co. Ltd.) | |
| Talc | 2.5 parts |
| (MICRO ACE P3, manufactured by Nippon Talc Co., Ltd.) | |
| Methyl ethyl ketone | 75 parts |
| Toluene | 75 parts |

### (Kick Evaluation)

The back face layer and the dye layer of the thermal transfer sheet of each Example and Comparative Example were placed opposite to each other and stored under a load of 15 kg/cm² in an environment of 40° C. and 90% humidity for 96 hours to allow the dye in the dye layer to migrate (kick) to the back face layer side. The hues of the back face layer before and after placed opposite were measured on GRETAG Spectrolino (D65 light source, viewing angle 2°) manufactured by Gretag Ltd., and the color difference(ΔE*) was calculated by the following expression and evaluated on the basis of the following criteria. The evaluation test results are also shown in table 1.

ΔE*=((Difference between L*values before and after opposition)²+(Difference between a*values before and after opposition)²+(Difference between b*values before and after opposition)²)^{1/2}

### “Evaluation Criteria”

⊚: Color difference ΔE* is less than 2.5
∘: Color difference ΔE* is not less than 2.5 and less than 3.0
Δ: Color difference ΔE* is not less than 3.0 and less than 5.0
x: Color difference ΔE* is not less than 5.0

### (Printing Irregularities (Gray) Evaluation)

The thermal transfer sheet of each Example and Comparative Example obtained above was set in a sublimation type thermal transfer printer (DS-40 manufactured by DNP Fotolusio Co., Ltd.) and left in an environment of 22.5° C. and 50% for an hour. Then, a black solid (255/255 gradation) image, three gray solid images (190/255 gradation, 128/255 gradation, and 64/255 gradation), and white solid (0/255 gradation) image were formed on genuine DS-40 image receiving paper. The obtained images of each pattern were visually observed to evaluate printing irregularities under the following evaluation criteria. The evaluation test results are also shown in table 1.

### “Evaluation Criteria”

⊚: No irregularities occurred in all the images
∘: Slight irregularities, at the level in which no problems are caused in the actual specification, have occurred in one of the five images
Δ: Irregularities, at the level in which actual damages are caused, have occurred in one or two of the five images
x: Irregularities, at the level in which actual damages are caused, have occurred in three or more of the five images

### (Head Abrasion Evaluation)

The thermal transfer sheet of each Example and Comparative Example obtained above was set in a sublimation type transfer printer (DS-40 manufactured by DNP Fotolusio Co., Ltd.) and left in a low-temperature and low-humidity environment (5° C., 20%) for three hours. Then, 400 black solid (255/255 gradation) images were continuously printed on genuine DS-40 image receiving paper. Thereafter, images of each pattern were formed by printing three pattern images: 195/255 gradation, 135/255 gradation, and 75/255 gradation on this thermal transfer image receiving sheet. The obtained images of each pattern were visually observed for roughness, and abrasion of the head was evaluated under the following evaluation criteria. The evaluation test results are shown in table 1. Roughness means infinite subtle density irregularities observed across the entire image colored part. Lower roughness means lower head abrasion.

### “Evaluation Criteria”

∘: Good with occurrence of no roughness in all the images
x: Occurrence of roughness, which leads to problems in use, has been observed in each image.

### (Gloss Evaluation)

The thermal transfer sheet of each Example obtained above was set in a sublimation type transfer printer (DS-40 manufactured by DNP Fotolusio Co., Ltd.) and left in an environment of 22.5° C. and 50% for an hour. Then, printed articles of each Example were obtained by forming a black solid (255/255 gradation) image on genuine DS-40 image receiving paper followed by transferring the protective layer of a genuine DS-40 ribbon thereon. The gloss of the printed articles was measured using Gloss Meter VG2000 (manufactured by NIPPON DENSHOKU INDUSTRIES CO., LTD.) at a measuring angle of 45°, and the gloss was evaluated under the following evaluation criteria. The evaluation test results are also shown in table 1. Incidentally, the gloss was evaluated only on the thermal transfer sheets of Examples.

### “Evaluation Criteria”

⊚: The gloss measurement result is not less than 80.
∘: The gloss evaluation result is more than 60 and less than 80.
Δ: The gloss measurement result is not more than 60.

TABLE 1

| | | Printing | | |
|---|---|---|---|---|
| | | irregularities | Head | |
| | Kick | evaluation | abrasion | Gloss |
| | evaluation | (gray) | evaluation | evaluation |
| Example 1 | ◯ | ⊚ | ◯ | ⊚ |
| Example 2 | ◯ | ⊚ | ◯ | ⊚ |
| Example 3 | ◯ | ⊚ | ◯ | ⊚ |
| Example 4 | ⊚ | ⊚ | ◯ | ⊚ |
| Example 5 | ⊚ | ◯ | ◯ | ⊚ |
| Example 6 | ◯ | ⊚ | ◯ | ⊚ |
| Example 7 | ◯ | ⊚ | ◯ | ◯ |
| Example 8 | ◯ | ⊚ | ◯ | ⊚ |
| Example 9 | ⊚ | ◯ | ◯ | ⊚ |
| Example 10 | ⊚ | ⊚ | ◯ | ⊚ |
| Comparative | ⊚ | X | ◯ | Not |
| Example | | | | evaluated |
| Comparative | ⊚ | X | ◯ | |
| Example | | | | |
| Comparative | X | ◯ | X | |
| Example | | | | |

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2014-200455 filed on Sep. 30, 2014 including the specification, claims, drawings and summary is incorporated herein by reference in its entirety.

### DESCRIPTION OF REFERENCE NUMERALS

1 - - - substrate
3 - - - color material layer
4 - - - protective layer
5 - - - back surface layer
10 - - - thermal transfer sheet

1-4. (canceled)

5. A thermal transfer sheet comprising a substrate, one or both of a color material layer and a protective layer provided on one surface of the substrate, and a back face layer provided on the other surface of the substrate;
wherein the back face layer comprises
(i) a cured acrylic polyol resin in which an acrylic polyol resin is cured by a curing agent, and
(ii) a glycerin fatty acid ester or a polyglycerin fatty acid ester.

6. The thermal transfer sheet according to claim 5, wherein the back face layer contains, as the (ii), a glycerin fatty acid ester having a melting point of not more than 25° C. or a polyglycerin fatty acid ester having a melting point of not more than 25° C.

7. The thermal transfer sheet according to claim 5, wherein the back face layer contains, as the (i), a cured acrylic polyol resin in which an acrylic polyol resin having a glass transition temperature (Tg) of not less than 80° C. and not more than 120° C. is cured by a curing agent.

8. The thermal transfer sheet according to claim 6, wherein the back face layer contains, as the (i), a cured acrylic polyol resin in which an acrylic polyol resin having a glass transition temperature (Tg) of not less than 80° C. and not more than 120° C. is cured by a curing agent.

9. The thermal transfer sheet according to claim 5, wherein the back face layer further contains a cellulose acetate butyrate resin.

10. The thermal transfer sheet according to claim 6, wherein the back face layer further contains a cellulose acetate butyrate resin.

11. The thermal transfer sheet according to claim 7, wherein the back face layer further contains a cellulose acetate butyrate resin.
